(19) United States
(12) Patent Application Publication
(10) Pub. No.: US 2005/0162140 A1
(43) Pub. Date: Jul. 28, 2005

(54) Apparatus including switching circuit

(76) Inventor: Mark Hirst, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/846,451

(22) Filed: May 14, 2004

Related U.S. Application Data
(63) Continuation-in-part of application No. 10/763,664, filed on Jan. 23, 2004.
(63) Continuation-in-part of application No. 10/764,409, filed on Jan. 23, 2004.

(51) Int. Cl. G05F 1/40

(52) U.S. Cl. 323/273

(57) ABSTRACT

A switching circuit has a first Field Effect Transistor (FET) having a first source, a first gate and a first drain, a second FET having a second source coupled to the first source and a second gate coupled to the first gate, a first diode having a first anode coupled to the first source and a first cathode coupled to the first drain, and a second diode having a second anode coupled to the second source and a second cathode coupled to the second drain. In addition, a load is coupled to the switching circuit and a control circuit is coupled to the switching circuit.

### CROSS-REFERENCES TO RELATED APPLICATIONS

This application is a continuation-in-part of, and claims priority to, co-pending application having Ser. No. 10/763,664 (attorney's docket number 200300840-1, entitled “Alternating Current Switching Circuit”) which was filed on Jan. 23, 2004. This application is a continuation-in-part of, and claims priority to, co-pending application having Ser. No. 10/764,409 (attorney's docket number 200311455-1, entitled “Power Converter”) which was filed on Jan. 23, 2004 and which is hereby incorporated by reference herein.

### BACKGROUND

Alternating Current (AC) power control provides a unique set of challenges to those working in the field. There are few solid state electrical devices, such as thyristors and triacs, that will allow AC power to be controlled directly. For both thyristor and triacs the switching times are comparatively long. These long switching times typically limit these devices to low frequency applications, typically AC frequencies of 50-60 Hz. Additionally, full wave rectification to convert AC to direct current (DC), to facilitate work with DC, can result in, among other things, undesirable current harmonics, high frequency conducted emissions that, if not filtered, result in unacceptable noise going back to the power company on the AC power supply lines, and power losses associated with the hardware for performing the full wave rectification.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an AC MOSFET switch, including anti-parallel diodes, in accordance with one embodiment.

FIG. 2 illustrates a more detailed look at an AC MOSFET switch, including intrinsic parasitic diodes of the MOSFETs, in accordance with one embodiment.

FIG. 3 illustrates current that is delivered to a load when one embodiment of the AC MOSFET switch is utilized to control current.

FIGS. 4A-4C illustrate a power filter and its effects on the current drawn by a load driven by an AC MOSFET switch, in accordance with one embodiment.

FIG. 5 illustrates an AC MOSFET switch design including a snubbing device, in accordance with one embodiment.

FIG. 6 illustrates a single IC device containing two NMOS type MOSFET devices of an AC MOSFET switch, in accordance with one embodiment.

FIG. 7A illustrates a portion of an embodiment of an inductive heating system utilizing an embodiment of an AC MOSFET switch, in accordance with one embodiment.

FIG. 7B illustrates a model for an inductive heating element, in accordance with one embodiment.

FIG. 8A illustrates an embodiment of a totem pole configuration of two AC MOSFET switches driving a series resonant circuit, in accordance with one embodiment.

FIG. 8B illustrates the timing, for one embodiment, of the two gate drive signals with respect to their reference points as supplied to AC MOSFET switches.

FIG. 9 illustrates an embodiment of an inductive heating system utilizing an embodiment of an AC MOSFET switch, in accordance with another embodiment.

FIG. 10 illustrates an embodiment of a subsystem utilizing an embodiment of an AC MOSFET switch to provide power control to a printer fusing system using a resistive type heating element, in accordance with one embodiment.

FIG. 11 illustrates an embodiment of a subsystem utilizing an embodiment of an AC MOSFET switch to provide power to a single phase, alternating current inductive motor, in accordance with one embodiment.

FIG. 12A illustrates a duty ratio of current delivery during startup of an exemplary induction motor, in accordance with one embodiment.

FIG. 12B illustrates the current delivered to an embodiment of an AC load over a two second ramp up period corresponding to FIG. 12A, in accordance with one embodiment.

FIG. 13 illustrates a duty ratio for operating an embodiment of an AC MOSFET switch during startup, in accordance with another embodiment.

FIG. 14 illustrates an embodiment of an imaging device, suitable for housing an apparatus utilizing an embodiment of an AC MOSFET switch, in accordance with one embodiment.

### DETAILED DESCRIPTION OF THE EMBODIMENTS

Although specific embodiments will be illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims.

The following discussion is presented in the context of MOSFET devices. It is understood that the principles described herein may apply to other transistor devices.

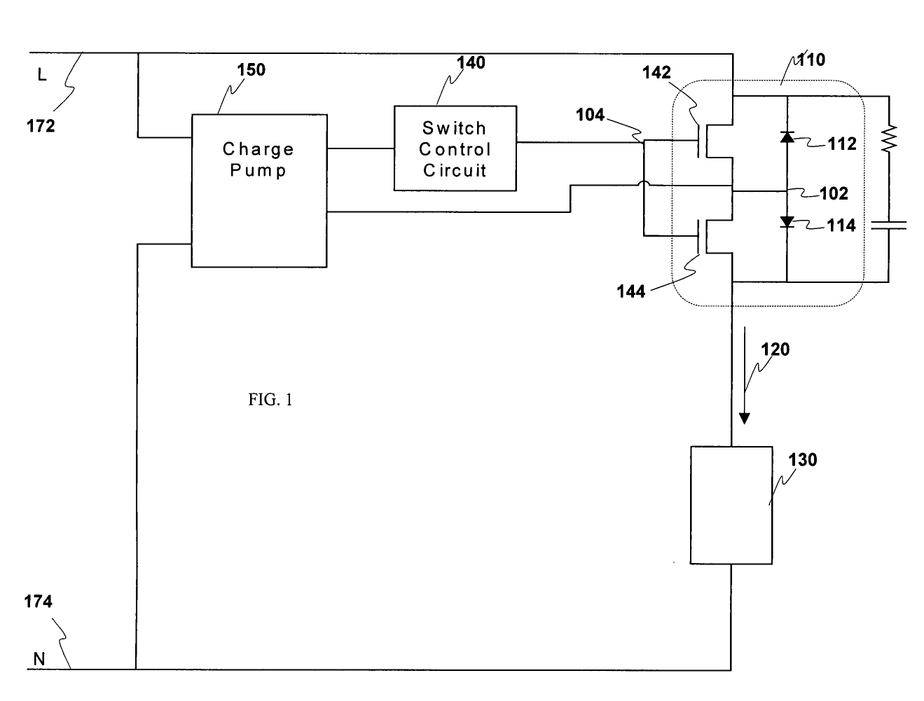

Refer now to FIG. 1 wherein an AC MOSFET switch 110, including anti-parallel diodes 112 114, is illustrated, in accordance with one embodiment. For the MOSFETs 142 144 illustrated, the sources of the MOSFET devices are coupled at junction 102. In one embodiment, MOSFETs 142 144 are power MOSFETs. In addition, the gates are electrically coupled at junction 104. These couplings are to facilitate the operation of the two MOSFETs 142 144 as a single AC MOSFET switch. Thus, by applying a gate to source voltage, V_{GS}, greater than the threshold voltage, V_{TH}, to the two MOSFETs 142 144, both MOSFETs conduct current 120.

Also illustrated in FIG. 1 are two diodes 112 114. These diodes 112 114, which may be parasitic or explicit, are anti-parallel to their respective MOSFETs. As described in further detail below, these diodes 112 114 may be utilized to bypass the intrinsic anti-parallel diodes of the MOSFETs. Thus, as illustrated, the anodes of the diodes 112 114 are coupled to the sources of the diodes' respective MOSFET and the cathodes are coupled to the respective drains.

FIG. 1 also illustrates the AC MOSFET switch in use in controlling power to a load. As previously mentioned, AC MOSFET switch 110 comprises two MOSFETs 142 144. AC MOSFET switch 110 controls current 120 through load 130. This may be accomplished by switch control circuit 140 which applies the gate-source voltages for the two MOSFETs 142 144 forming the AC MOSFET switch 110. In the embodiment illustrated, charge pump biasing circuit 150 supplies current to switch control circuit 140 from line (L) 172 and neutral (N) 174 connections of the AC power source.

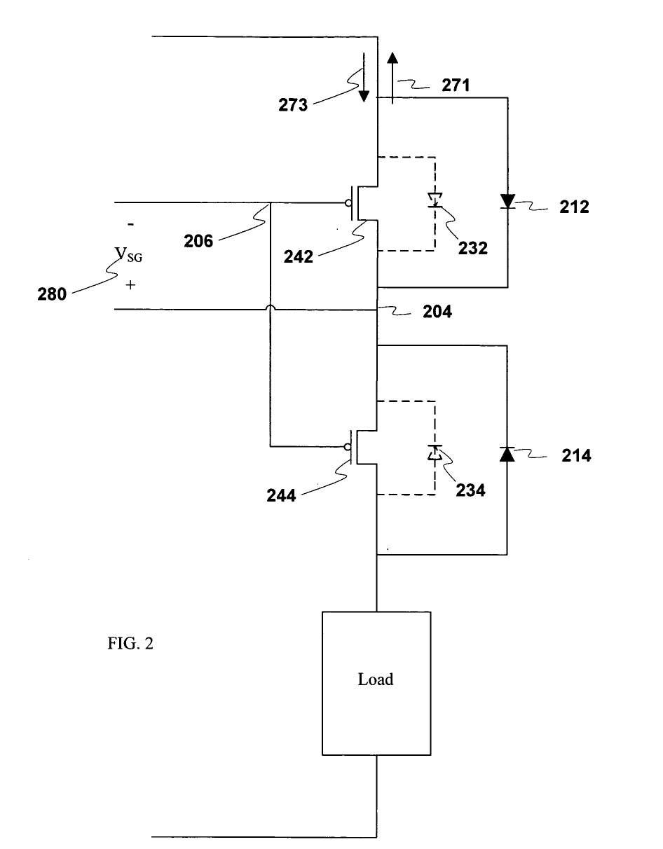

FIG. 2 illustrates a more detailed look at an AC MOSFET switch, utilizing P type MOSFETs, including intrinsic parasitic diodes 232 234 of the MOSFETs 242 244, in accordance with one embodiment. Also illustrated are antiparallel diodes 212 214 which may be utilized to bypass the intrinsic anti-parallel diodes 232 234 of the MOSFETs. Note that the sources of both MOSFETs 242 244 are coupled 204 to each other. In addition, the gates of both MOSFETs 242 244 are coupled 206 to each other. When a voltage, V_{SG} 280 less than a threshold voltage V_{TH} is applied, the MOSFETs 242 244 will be “turned-off” and the internal reverse biased PN junctions will substantially prevent current from flowing through the MOSFETs.

When a voltage, V_{SG} 280 greater than a threshold voltage V_{TH} is applied to the common sources and gates of MOSFETs 242 244 are turned on to facilitate the flow of current through the AC MOSFET switch. Note that current will flow in the reverse direction in MOSFET 242 or 244 depending on the polarity of the AC voltage source. That is, in the reverse direction as is normally used in DC circuits, that is drain to source in an N type MOSFET or source to drain in a P type MOSFET. The reverse current flow causes no problem as the MOSFET transistor is truly a bidirectional device, that is, current may flow from drain to source or source to drain once the proper gate voltage is applied and the conductive channel forms. Normally, during reverse polarity across the source/drain of a MOSFET, an internal PN junction, represented by parasitic diodes 234 and 232 in FIG. 2, will eventually turn on allowing current 271 to flow. Note that parasitic diodes 234 and 232 are not separate from the MOSFET 244 and 242; e.g. parasitic diode 234 is a PN junction that is part of the structure of transistor 244. Once the gate voltage is removed the parasitic diode conducts during reverse current flow which makes a single MOSFET unsuitable for the control of alternating current 271 273. The common source configuration of MOSFET 242 and 244 of FIG. 2 results in one of the parasitic diodes in a reverse biased state which substantially prevents current flow through the parasitic diodes 232 234 when the MOSFETs are in either the conducting or nonconducting states.

Referring again to FIG. 1, switch control circuit 140 and charge pump circuitry 150 are utilized to provide control for the application of the voltage to the gates of MOSFETs 142 144. In the embodiment illustrated, switch control circuit 140 may be an externally controlled pulse width modulation circuit. In the embodiment illustrated, charge pump 150 utilizes the AC line to power the pulse width modulation circuitry. In addition, the frequency of the modulated control signal may be fixed, whereas the duty cycle of the modulation, as described below, is utilized to determine the power to be delivered to the load 130. In an alternative embodiment the gate and source of the AC MOSFET may be driven by a circuit which has a minimum conduction time combined with a variable frequency to determine the power to be delivered to the load 130.

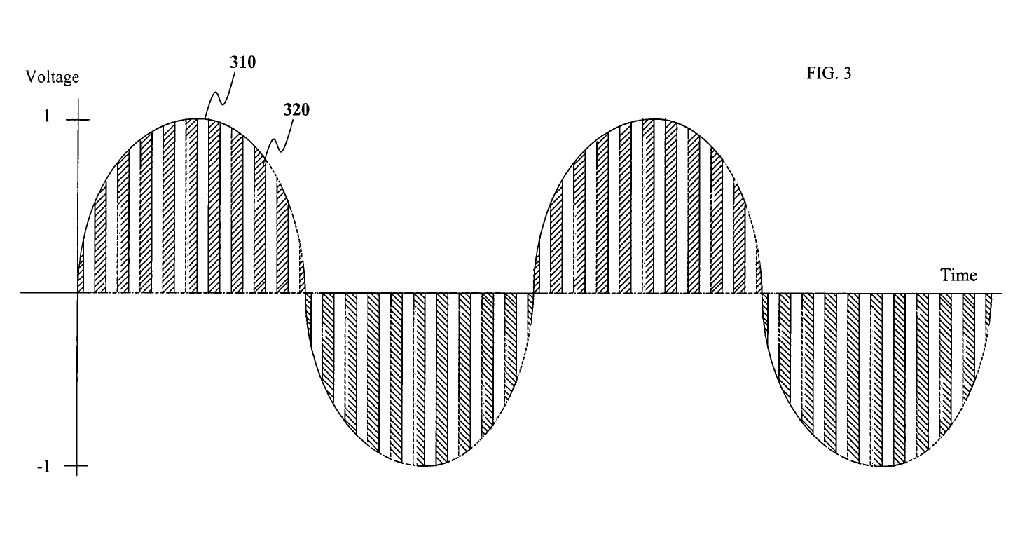

FIG. 3 illustrates current that is delivered to a load when one embodiment of the AC MOSFET switch is utilized to control current. For example, as discussed above with respect to FIG. 1, the switch control circuit 140 may be a pulse width modulation circuit. In such a case, the power delivered to the load 130 can be controlled by changing the duty cycle of the pulse control signal. FIG. 3 illustrates an example input voltage 310 from the line and neutral. Illustrated also, in the dark shaded regions 320, are the periods where the AC MOSFET switch 110 is switched on to allow current to flow through the load 130. The voltage 310 and current 320 are normalized so that they share a common envelope. Thus, in the illustrated embodiment, a 50% duty cycle signal driving the gate to source voltage will result in an effective power of one half the total power available being delivered the load. By utilizing a pulse width modulation technique, the level of power delivered to the load can be adjusted by controlling the width of the pulses generated by the pulse width modulation of the switch control circuit. The equation governing the power transfer to the load is:

$$Pavg = \frac{{Vrms}^{2}}{R} \cdot d .$$

Where Vₘₛ is the Root Mean Square (rms) voltage of the AC power source, R is the resistance of the load and d is the duty ratio of the pulse width modulator driving the AC MOSFET. By inspection of this equation, the power transferred to the load is a linear function of the duty ratio of the pulse width modulator. The load is at zero power when the duty ratio is zero and at maximum power when the duty ratio is 1.

In an alternative embodiment in which the gate and source of the AC MOSFET switch are driven by a circuit which has a minimum conduction time combined with a Variable Frequency Oscillator (VFO) the power delivered to the load 130 is determined by
P=V²÷R×ƒ×Tₘᵢₙ
Where V is the rms voltage of the AC power source, R is the resistance of the load, f the frequency of the VFO driving the AC MOSFET and Tₘᵢₙ the minimum conduction time allowed. By inspection, this equation shows that the power transferred to the load is a linear function of the frequency of the VFO. The load is at zero power when the VFO frequency is 0 and at maximum power when the period of the frequency of the VFO is equal to or less than the minimum allowed conduction time Tₘᵢₙ.

The above examples operate to facilitate the switching of the alternating current at relatively higher frequencies. There are advantages to switching the current at relatively higher frequencies. Switching frequencies out of the audio range (e.g. greater than 20 KHz) can be utilized to reduce human factor issues associated with audible switching noise. Another advantage of operation at higher frequencies may be a reduction in switching and conduction losses. Implementations operating at significantly lower frequencies spend more time in the linear region of operation. Spending more time in the linear region during switching may dissipate significant amounts of additional energy in the form of heat as relatively slow transitions are made through this linear region. In addition, because of the relatively low voltage drops associated with the disclosed switching of alternating current, less energy is dissipated from the product of the current flowing across the voltage drops of the devices. In addition, the AC MOSFET switching circuit above does not introduce significant harmonics into the alternating current. This can reduce costs associated with filtering these harmonics to meet international regulatory requirements.

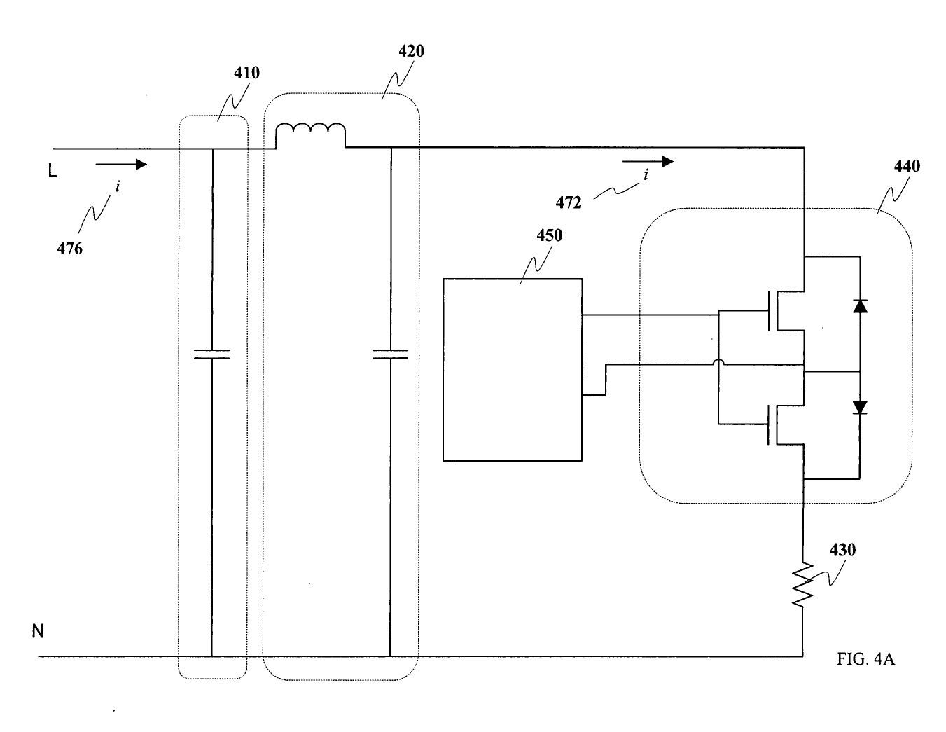

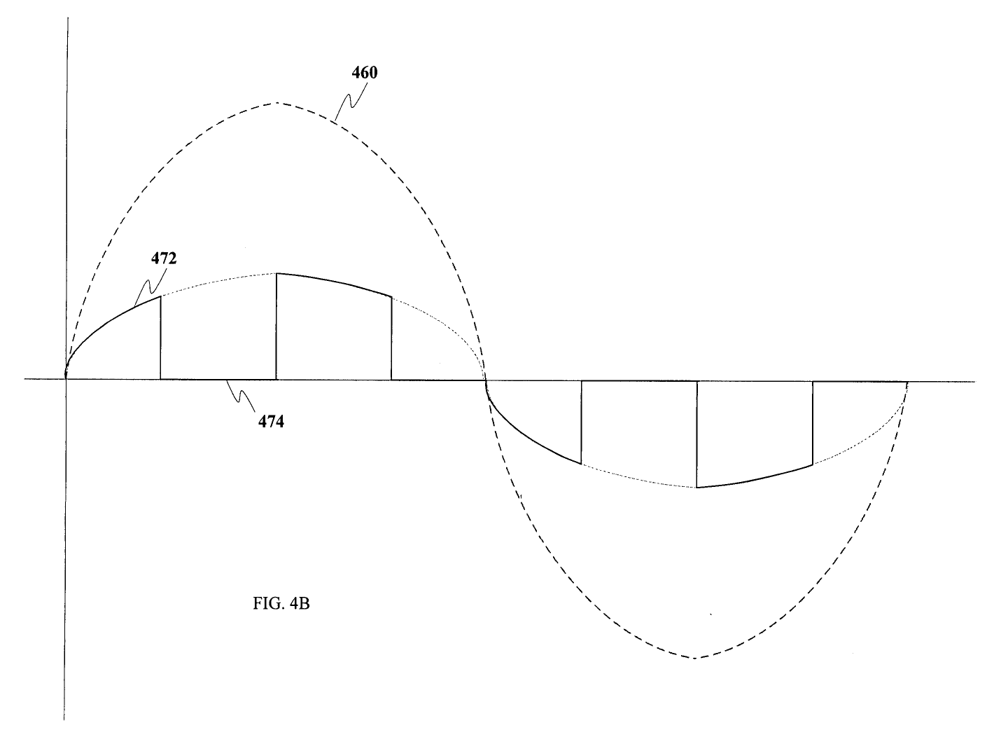

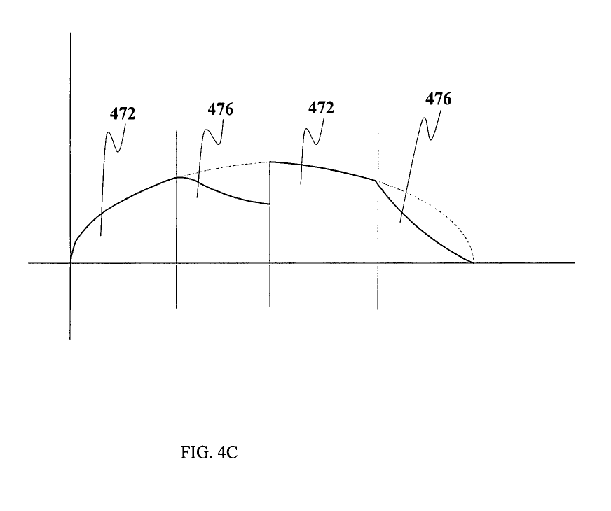

FIG. 4A illustrates input circuitry for an AC MOSFET switch, in accordance with one embodiment. Illustrated is a filter stage 410 to provides a high frequency short to ground to any transients or conducted emissions that occur across the inputs. Illustrated also is a filtering stage 420 to provide smoothing of the alternating current drawn by the load 430. The effect of this filter is to smooth the harmonic rich current drawn by the pulse width modulated, or VFO driven load, such that the power source experiences a continuous current flow with virtually no harmonic current content.

In the embodiment, switch control circuit 450 switches the current 472 delivered to the load as illustrated in FIG. 4B. During times of switching, assuming a purely resistive load, the current 472 through the load 430 will follow the line voltage provided, that is, it will be in phase. When the switch is turned off, the current delivered to the load will drop to zero 474. Thus, as can be seen there will be dramatic shifts or steps in the current drawn by the load as the switch turns on and off. These step changes in the current represent unwanted current harmonics placed on the AC power source which may exceed regulatory limits. To solve this problem, filtering stage 420 is added to the circuit. FIG. 4C illustrates the current drawn from the AC power source at the line and neutral connections by the switched load as a result of the filtering stage 420. When the switch is turned off, the filtering stage 420 smoothes current 476 drawn by the load 430. In the case in which the switch is driven by a pulse width modulator, the total instantaneous current drawn by the circuit may be the sum of the fundamental current and the instantaneous value of the ripple current. This instantaneous current may be expressed as

$${i}_{L} ( t ) = \frac{V \cdot d}{R} \cdot sin ( 2 \cdot π \cdot {f}_{o} \cdot t ) + \frac{{π}^{2}}{4} \cdot ( 1 - d ) \cdot {( \frac{{f}_{c}}{{f}_{s}} )}^{2} \cdot \frac{V \cdot d}{R} \cdot sin ( 2 \cdot π \cdot {f}_{o} \cdot t ) \cdot sin ( 2 \cdot π \cdot {f}_{s} \cdot t ) .$$

where f_{c} is the resonant frequency of filtering stage 420, fₛ is the switch frequency of the pulse width modulator, fₒ is the frequency of the AC power source, d is the duty cycle of the pulse width modulator, V is the peak source voltage, and R is the load resistance 430. Under direct examination of this equation it is noted that, as the switch frequency of the pulse width modulator is increased, the resultant alternating current waveform at the Line and Neutral connections smoothes dramatically.

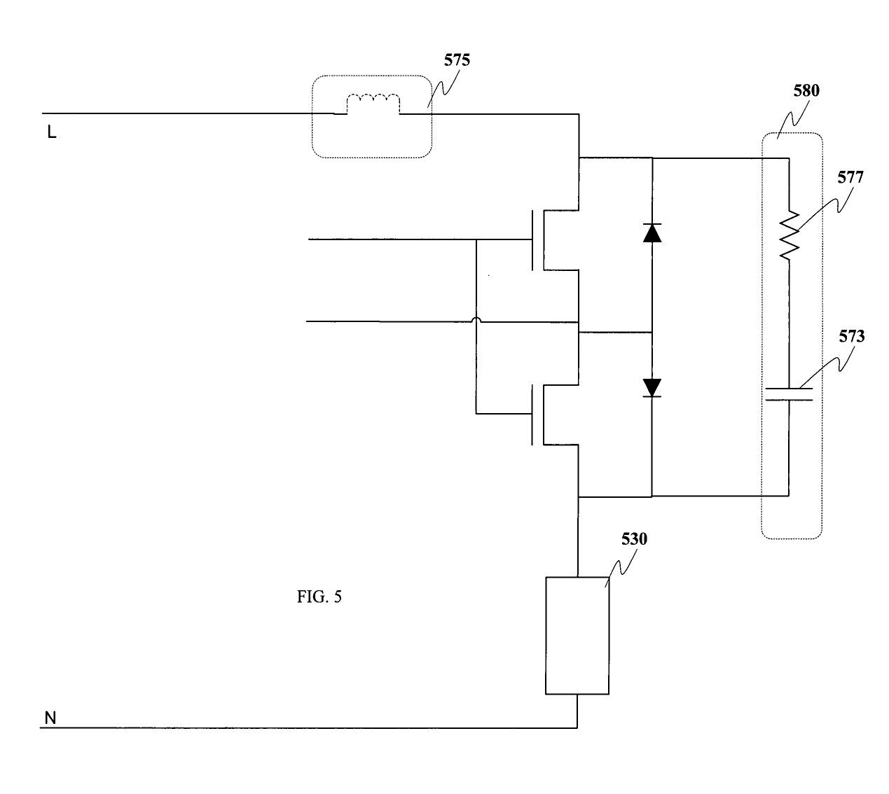

FIG. 5 illustrates an AC MOSFET switch design including a snubbing device 580, in accordance with one embodiment. Snubbing device 580 is utilized for dissipating energy stored in the circuit. Stored energy in a circuit exists due to various factors associated with the circuit such as: parasitic inductance associated with the wiring providing the AC current, parasitic inductance in the components leads, and inductance in the load itself. Snubber designs are designed to capture a portion of the stored energy in a circuit, when the circuit is switched off. These snubber designs are to reduce, among other things, the resonance of the circuit. However, these snubber designs are not engineered to dissipate all the energy; they are simply designed to dissipate enough energy to reduce resonance and the resulting resonant “over” voltages that may otherwise occur.

To dissipate all the energy in the circuit, a significantly larged sized capacitor 573 may be used in snubber 580 design. It is desirable to have the resistance 577 approximately match the resistance in the load 530. Thus, if the load resistance is approximately 20 ohms, then the resistance of the snubber should be selected to be about 20 ohms. In addition, the stored inductance 575 for a typical circuit driving the AC MOSFET switch has been measured at approximately 100 nanoHenries. In some snubber designs, a capacitor capable of capturing about ⅕ of the energy stored in the inductive parasitics may be utilized. As mentioned, this capacitor size is utilized to simply avoid resonance of the circuit. However, the remaining energy is dissipated via heat in the switching element or as Radio Frequency (RF) emissions. To avoid this heat or RF emissions, a larger snubber circuit may be utilized.

In order to have the snubber dissipate substantially all the stored energy of the circuit, the energy dissipated by the snubber should equal the energy stored due to the inductance of the circuit. Thus,
½LI²=½ CV², where I=V/R
½ L(V/R)²=½ CV²
Solving for C we find that:
C=L/R²
Thus, the capacitor used is directly related to the value of the parasitic inductance.

Dissipating heat may be undesirable as it may result in damage to the circuit. A solution to this may be to include a heat sink. However, the addition of the heat sink may add cost to the design. In addition, generation of RF emissions may be undesirable as it may result in poor classification during RF certification proceedings for the device containing the AC MOSFET switch. To protect from RF emissions, a shield for the RF emissions may be provided. Again, however, the addition of a shield may add cost to the design.

Thus, in one embodiment, the capacitor that is part of the snubber illustrated in FIG. 5 is designed to capture substantially all of the stored energy in the circuit associated with the AC MOSFET switch. In this manner, the design of RF shield and the design of any heat dissipating devices may be reduced.

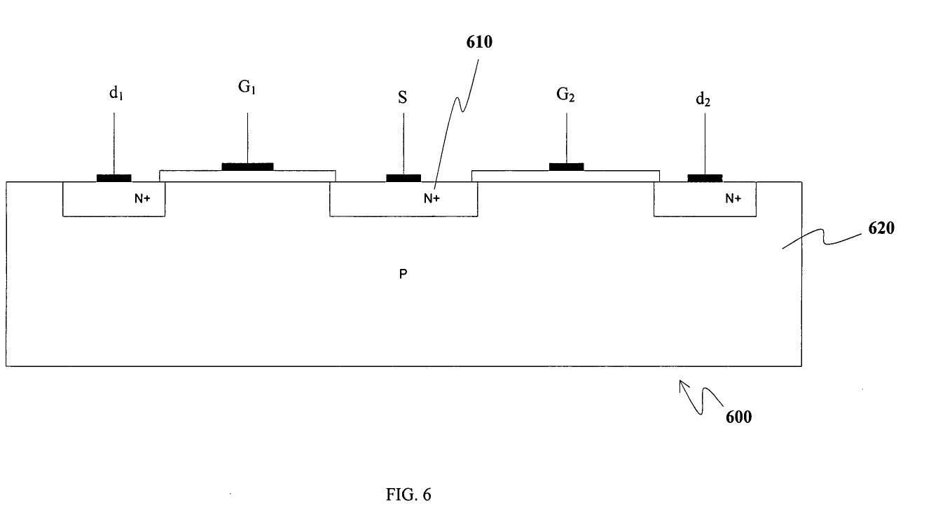

FIG. 6 illustrates a single integrated circuit (IC) device 600 containing two NMOS type MOSFET devices of an AC MOSFET switch, in accordance with one embodiment. In an alternative embodiment, two PMOS type MOSFET devices may be utilized in the construction of an AC MOSFET switch. Recall that the two sources from the two MOSFETs are logically coupled to each other in the AC MOSFET switch. By fabricating the two MOSFETs in a single package on an IC, the two MOSFETs may share a common source region 610 on the IC. In the embodiment illustrated in FIG. 6, a common source region 610 is implanted into the die containing the AC MOSFET switch. The sharing of the common source region 610 may allow the use of a single source lead emanating from the package containing the two MOSFETs of AC MOSFET switch. This, in turn, may result in decreased conduction resistance due to the elimination of one source lead and the source lead's associated wire bonding parasitics, such as ohmic resistance from the die to a package lead. For example, in one embodiment, the elimination of one of the source leads may reduce the impedance by 70 milliohms, corresponding to the impedance associated with one of the leads to the AC MOSFET switch.

70 milliohms may be a substantial portion of the overall resistance associated with the AC MOSFET switch. For example, assume an R_{DSON} of 100 milliohms for each MOSFET in the AC MOSFET switch. Thus, with a 70 milliohm resistance for each lead for the source and drain, the overall path impedance across the source and drain is 240 milliohms. Two discrete series devices have an effective resistance through the AC MOSFET switch of 480 milliohms. Recall that the external source lead in the AC MOSFET is used for the application of gate bias and as a conduction path for certain types of snubber applications during switch turn off. By design the external source connection 610 has very low current flow and does not introduce series resistance to the AC MOSFET switch when the switch is conducting. This fact allows the conduction resistance of the AC MOSFET switch to be reduced by 140 milliohms, or a reduction in effective resistance 30% by using a common source region on the die of the AC MOSFET and the elimination of one lead. Since the power dissipated is directly related to the resistance, this results in a 15% reduction in power loss, for the embodiment described. Fabrication of the AC MOSFET switch on a single die also allows one of the gate terminals of the discrete implementation to be eliminated. The result of the common source region and eliminated gate terminal is a four pin device with two high current drain connections and two lower current gate and source connections. One pin of the four pin device is coupled to each of the gates of the two MOSFETs. Another pin is coupled to the common source region , and each of the two remaining pins are coupled to a different one of the drains.

The AC MOSFET switch may be utilized in various devices and/or systems to control AC loads, in particular, inductive loads. Examples of systems with inductive loads include but are not limited to subsystems of photocopier and laser printing systems. Such subsystems may include fuser power control subsystems and inductive heating subsystems. Other devices, such as home appliances, containing induction motors may also utilize AC MOSFET switches for AC power control.

In the figures that follow, various aspects of the details of the AC MOSFET switch, such as the antiparallel diodes, are occasionally omitted to simplify the figures in order to not obscure the embodiments being described.

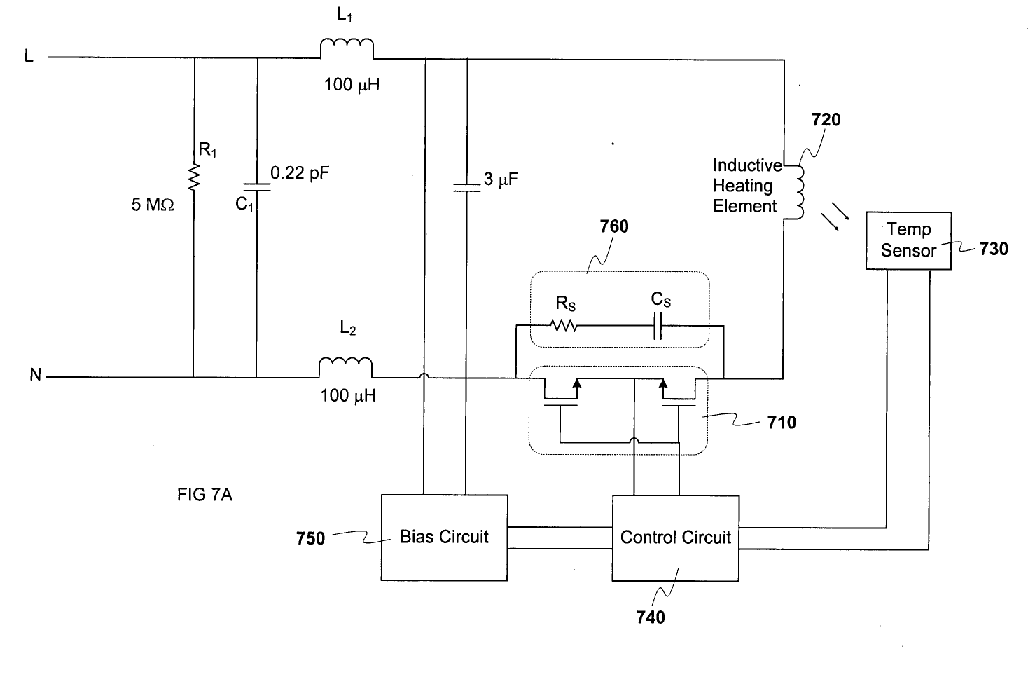

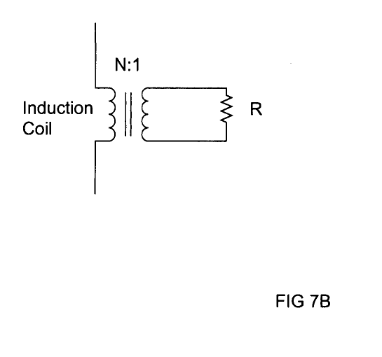

FIG. 7A illustrates a portion of an inductive heating system utilizing an embodiment of an AC MOSFET switch 710, in accordance with one embodiment. Utilizing the AC MOSFET switch 710 to control power to an inductive heating element 720 may reduce a substantial amount of the device losses, and possibly, as much as halves the total switching losses. In one embodiment, assuming a drain to source conduction resistance of 0.07 ohms in each of the two MOSFETs, the power dissipated is approximately:
2*0.07*8*8=8.96 Watts

As illustrated in FIG., 7B, inductive heating element 720 may be modeled as a simple N:1 transformer with a single turn on the secondary winding which is then connected to a very low value resistive load capable of handling very high power loads. Temperature sensor 730 may be utilized to provide a measurement of the heating element's temperature to the control circuit 740. Temperature sensor represents a typical temperature sensor, such as a thermistor, and will not be described further. The control circuit 740 may be utilized to provide control for AC MOSFET switch 710. That is, the control circuit may be utilized to determine when to allow alternating current to flow through the inductive heating element 720, thus controlling the power to the inductive heating element 720. An example of a control circuit 740 suitable for use with AC MOSFET switch 710 in controlling power in an inductive heating system is the control circuit disclosed in U.S. Pat. No. 5,789,723 titled “Reduced Flicker Fusing System for Use in Electrophotographic Printers and Copiers” (herein incorporated by reference). In alternate embodiments, other equivalent control circuits may be employed instead.

Bias circuitry 750 may be utilized to bias the control circuitry 740 and provide reference voltage for the gate to source voltage utilized in the biasing of the AC MOSFET switch 710. An example of a biasing circuit 750 suitable for use with the novel AC MOSFET switch 710 is the biasing circuit disclosed in U.S. Pat. No. 6,396,724 titled “Charge-pumped DC Bias Supply”. In alternate embodiments, other equivalent biasing circuits may be employed instead.

Recall that the AC MOSFET switch biasing voltages across the gate/source can float with respect to the voltage applied across the AC MOSFET switch 710. Accordingly, the biasing circuit 750 may be employed to electrically decouple or isolate the control circuit 740 from the AC power circuit. This may be performed using an isolation transformer. Note, however, that while using a transformer to provide isolation provides galvanic isolation, non-galvanic isolation is also possible; as long as the bias circuit can float with respect to the line or neutral.

R_{S}C_{S} 760 form a turn-off snubber for the AC MOSFET switch. Thus, upon switching the current off at the AC MOSFET switch 710, the energy stored in the parasitic inductance of the circuit can be dissipated through resistor/capacitor combination, instead of being directed at, and dissipated by, the AC MOSFET switch 710.

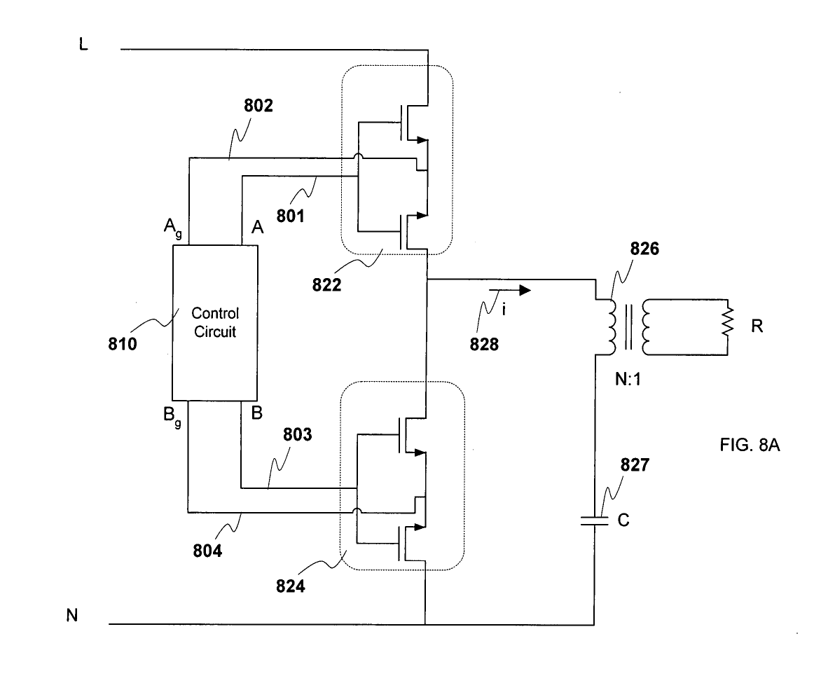

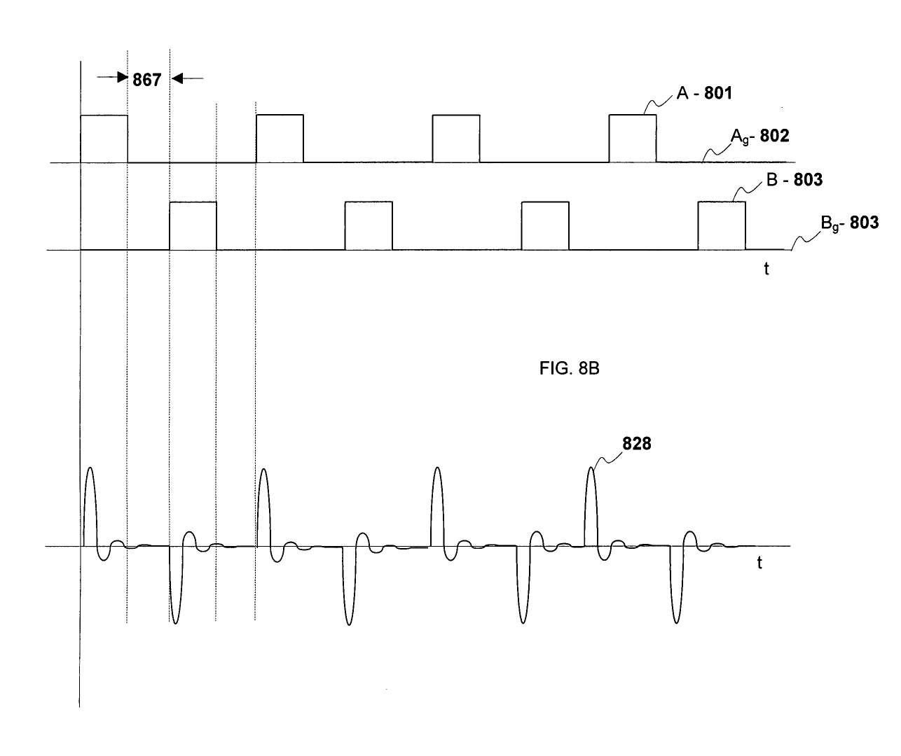

FIG. 8A illustrates an embodiment of a totem pole configuration of two AC MOSFET switches driving a series resonant circuit, in accordance with one embodiment. The series resonant circuit comprises an induction coil 826 and capacitor C 827. The series resonant circuit is used to heat a fusing unit in a laser printer and only the primary resonant circuit is shown. This totem pole configuration provides an ability to handle high resonant currents resulting from the switching off of an inductive load such as that of the induction coil 826. In this embodiment the power transfer from the line L and neutral N terminals of the AC power source to the item undergoing induction heating is a linear function of the drive frequency applied to the AC MOSFET switches as given in the following equation:

$$P ∝ \frac{1}{2} f \cdot C \cdot {V}^{2}$$

where f is the switch drive frequency, C the value of the series capacitance 827 and V the rms voltage of the AC power source. The totem pole configuration comprises two back-to-back AC MOSFET switches 822 824. In the embodiment illustrated, each of the two AC MOSFET switches 822 824 are controlled by control circuit 810. By utilizing two AC MOSFET switches 822 824 higher resonant currents may be tolerated.

FIG. 8B illustrates the timing, for one embodiment, of the two gate drive signals 801 803 with respect to their reference points 802 804 as supplied to AC MOSFET switches 822 824. Reference point 802 is attached to the common source of AC MOSFET 822 and reference point 804 is attached to the common source of AC MOSFET 824. FIG. 8B also illustrates the resulting current waveform 828 through the induction coil 826 with respect to the AC MOSFET drive signals. Assuming that AC MOSFET 822 is conducting and the voltage at the L (line) terminal is positive and the voltage at the N (neutral) terminal is negative, current waveform 828 will flow into coil 826 charging capacitor 827 and continue to the N terminal completing the circuit. This current flow starts out at zero amperes and will climb to a maximum and then attempt to resonate. The effective resistance across the secondary winding of the induction coil results in a highly damped oscillatory circuit and the resonant oscillations of current waveform 828 quickly die away to zero amperes. During this resonant current flow any metallic device placed near induction coil 826 may experience induced currents which result in energy transfer and the desired resulting heating of the metallic device placed near the induction coil 826. Next AC MOSFET 822 is turned off and, after a small time delay 867, AC MOSFET 824 will start to conduct. The time delay 867, in which both AC MOSFETs are off, is many times referred to as “dead time” or as a “blanking interval”. This time delay 867 may be utilized such that neither AC MOSFET will conduct at the same time. Such concurrent conducting may result in an effective ‘short circuit’ across the AC power source which may result in the destruction of the two AC MOSFETs 822 824. Next AC MOSFET 824 starts to conduct and a current will start a reverse flow out of capacitor 827 through induction coil 826 proceeding through AC MOSFET 824 and completing the circuit at capacitor 827. Energy is again transferred via the induction coil to the metallic device to be heated. The resonant current quickly dies out, and then AC MOSFET 824 is turned off and another period of dead time is applied. The process then repeats. Switching the AC MOSFETs 822 824 on and off at zero current substantially reduces the typical losses experienced while switching an inductive circuit and result in a significant increase in the efficiency of the converter.

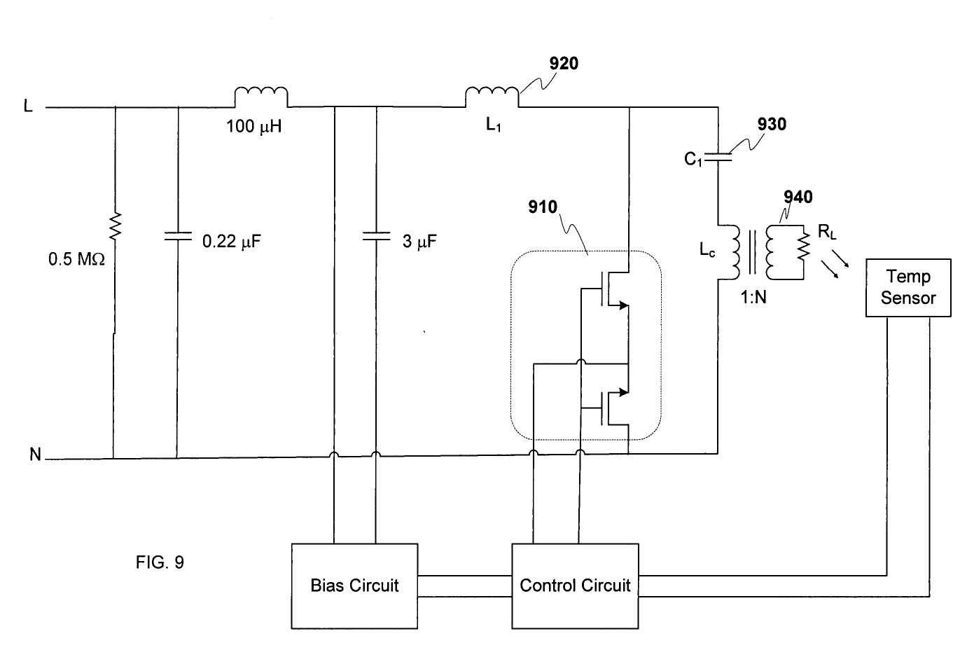

FIG. 9 illustrates an embodiment of an inductive heating system utilizing an embodiment of an AC MOSFET switch 910, in accordance with another embodiment. In this embodiment, to increase converter efficiency by reducing converter losses, a Cuk topology may be applied to an AC MOSFET switch design for an inductive heating element. When the AC MOSFET switch 910 is on, current builds in L₁ 920. In addition, charge from C₁ 930 is transferred through inductive coil L_{C} 940 to the load. This transfer of energy via an inductive heating element can be simply modeled as an N:1 transformer with a resistive load on the secondary winding. When the AC MOSFET switch 910 turns off, the energy in L₁ 920 is forced into the series resonant C₁L_{C} load. This approach reduces turn off switching loss in the AC MOSFET switch 910.

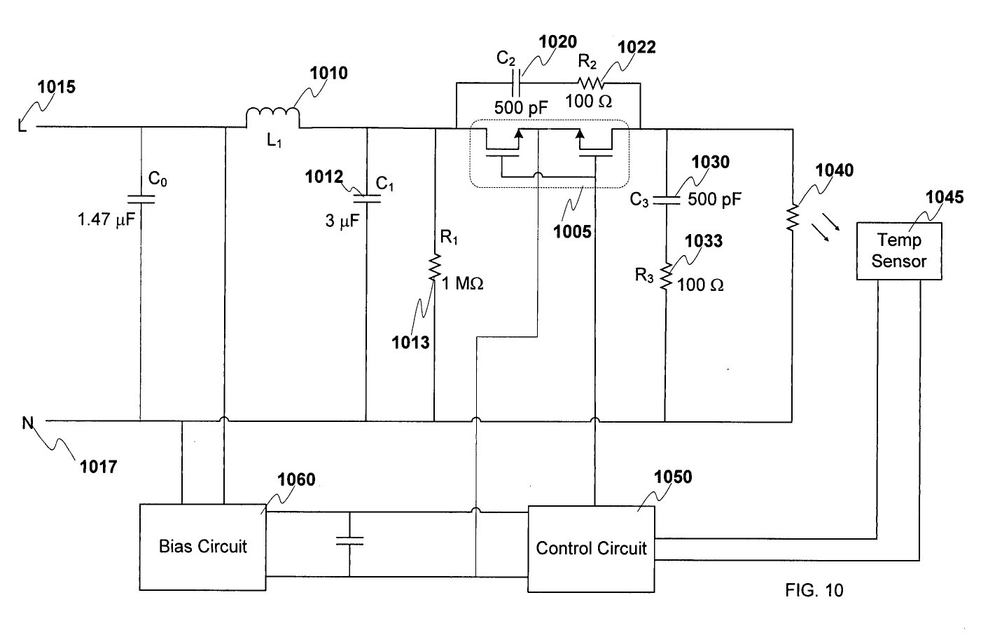

FIG. 10 illustrates an embodiment of a subsystem utilizing an AC MOSFET switch 1005 to provide power control to a printer fusing system using a resistive type heating element 1040, in accordance with one embodiment. L₁C₁ 1010 1012 act as a low-pass filter such that the AC source at L 1015 and N 1017 experiences a near pure resistive load for practical power levels. For example, a load ranging between 10 Watts to 1000 Watts enjoys a near unity power factor over the entire load range. R₁ 1013 is a safety precaution to discharge C₁ 1012 when the power controller of FIG. 10 is disconnected from the AC power source such that the voltage appearing at the L 1015 and N 1017 terminals is quickly reduced to zero volts. Capacitor C₀ 1011 may be placed across the L 1015 and N 1017 terminals to filter out conducted emissions that may otherwise be injected into the AC power source. The value specified for C₀ 1011 may be determined empirically. For example the value may be such that the power converter meets regulatory standards. However, the value typically falls into a range of approximately 1 uF per kilowatt that the converter controls. Thus, for a 1.2 kW maximum power load a standard value capacitance of 1.47 uF would be chosen for C₀ 1011.

R₂C₂ 1020 1022 and R₃C₃ 1030 1033 may act as turn off snubbers for the AC MOSFET switch 1005 and the fuser heating element 1040, respectively, to reduce radiated and conducted emissions. Temperature sensor 1045 may be utilized to monitor the fuser temperature and provide the sensed temperature as feedback to the control circuit 1050. The control circuit 1050 may be used to control the AC MOSFET switch 1005 and thus to control the current to the fuser's resistive heating element 1040. In this instance, resistive fuser heating element, is understood to include, various types of resistive elements such as screen printed film resistors, resistive element heating lamps, open air metallic resistance coils, etc. In one embodiment, the control circuit 1050 comprises a pulse width modulated (PWM) control circuit. In another embodiment, the control circuit 1050 comprises a variable frequency drive that yields a power transfer characteristic that varies with drive frequency. An example of a control circuit 1050 which may be utilized in conjunction with the novel AC MOSFET switch 1005 is the linear control circuit disclosed in U.S. Pat. No. 5,811,764 titled “Method for Reducing Flicker in Electrophotographics Printers and Copiers” (herein incorporated by reference). In alternate embodiments, other equivalent linear control circuits may be employed.

Bias circuit 1060 may be employed to provide DC voltages and currents for control circuit 1050 as previous discussed. An example bias circuit 1060 is disclosed in U.S. Pat. No. 6,396,724 titled “Charge-pumped DC bias supply” (herein incorporated by reference). Additional examples may be found in U.S. Pat. No. 6,563,726 titled “Synchronous bridge rectifier” (herein incorporated by reference). Finally, a regenerative snubber to provide bias to control circuit utilizing recaptured energy is disclosed in co-pending application Ser. No. 10/780,927 (attorney's docket number 200309715-1, entitled “SNUBBER CIRCUIT”) filed on Feb. 17, 2004.

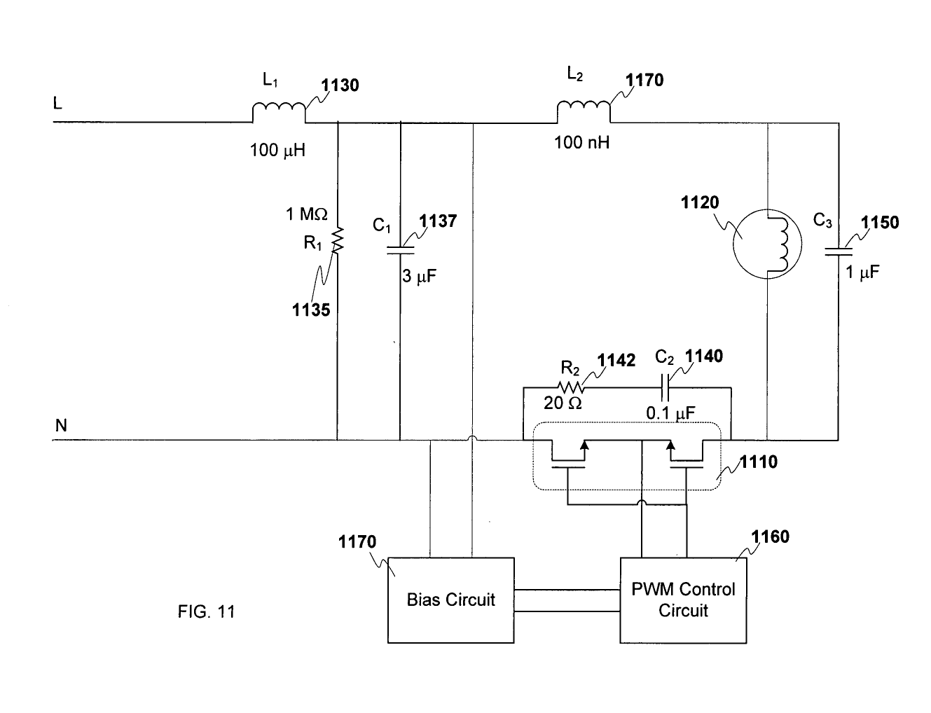

FIG. 11 illustrates an embodiment of a subsystem utilizing an AC MOSFET switch 1110 to provide power to a single phase, alternating current induction motor 1120, in accordance with one embodiment. L₁ 1130 and C₁ 1135 form a series resonant low pass filter that filters the current pulses supplied to the motor so that the AC source experiences a continuous load with very low levels of harmonics. R₁ 1137 may be employed as a safety feature to discharge C₁ 1135 in the event that service to the circuit may be performed. Free wheeling capacitor C₃ 1150 provides a continuous path for the current flowing through the motor when the AC MOSFET switch 1110 is turned off while the pulse width modulated control circuit 1160 is active. L₂ 1170 acts to limit current through C₃ 1150 when the AC MOSFET turns on. Resistor R₂ 1142 and capacitor C₂ 1140 form a turn off snubber to protect the AC MOSFET switch 1110 from energy stored in the inductance in the system which may cause over voltages in the AC MOSFET switch 1110 when the AC MOSFET switch 1110 is turned off. R₂ 1142 and C₂ 1140 may also act to reduce the power losses in the MOSFET devices of the AC MOSFET switch 1110. Additionally, R₂ 1142 and capacitor C₂ 1140 may filter high frequency electromagnetic noise that may otherwise appear as radiated electromagnetic radiation or conducted radiation which may be injected into the AC power source.

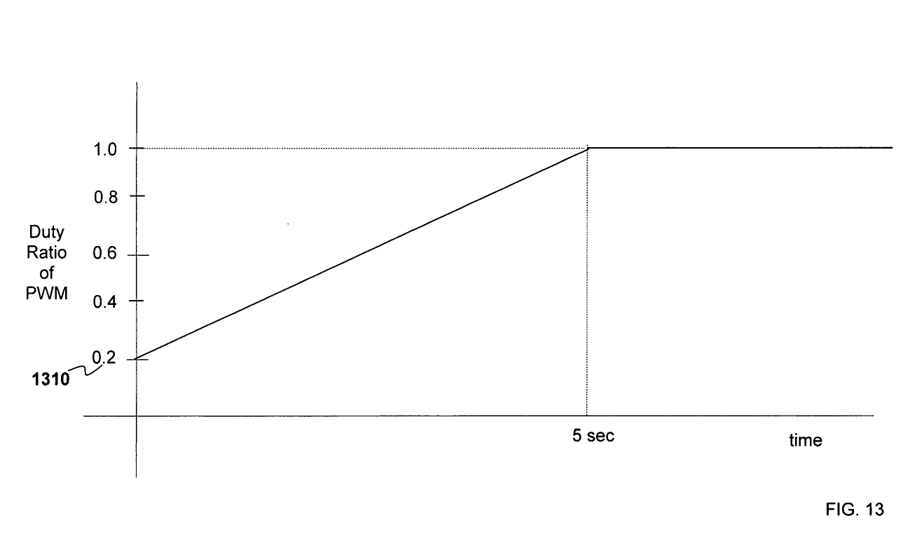

Another advantage of the utilization of an AC MOSFET switch design with the inductive loads, such as motors, disclosed herein, may be the ability to provide soft start functionality. As a motor begins to spin up after being turned on, the motor can produce a current surge that is approximately five times larger than the maximum rated current for a device. (And, please do not include FIG. 13 in the filed application.) This large start-up transient may react with the impedance in the wiring from the AC power source and cause voltage sags and surges. These voltage fluctuations may then cause the light output from light sources connected to the AC power source to flicker. Flicker is a very undesirable artifact and much attention is devoted to reducing it in AC power systems. An AC MOSFET switch circuit controlling such an inductive motor may be operated in a manner to facilitate control of this start up current.

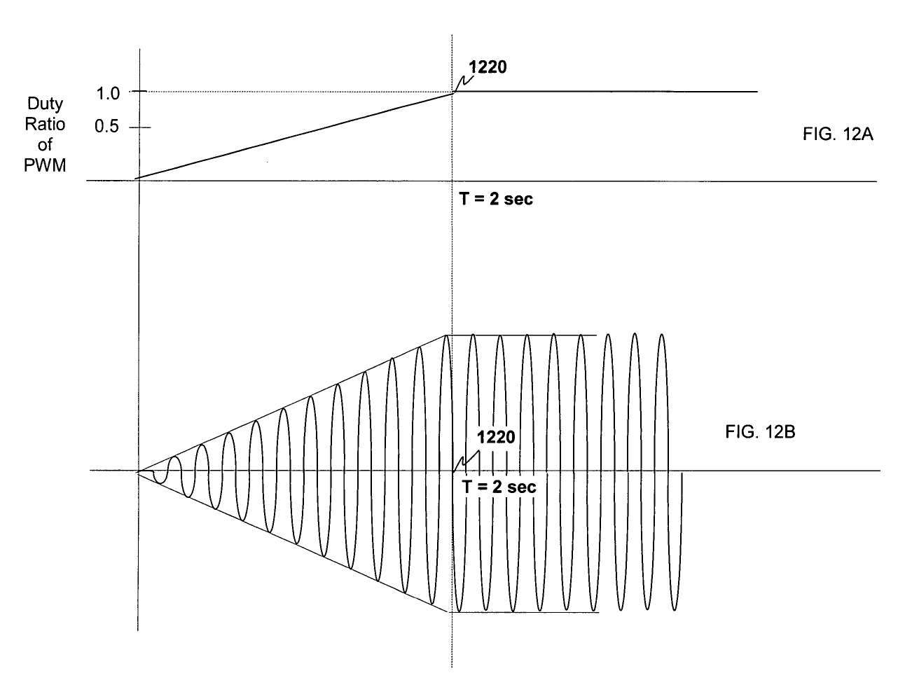

FIG. 12A illustrates a duty ratio of current delivery during startup of an exemplary induction motor, in accordance with one embodiment. The duty ratio is the ratio of time where switch is turned on versus the total period that it could be on. FIG. 12A illustrates a linear duty ratio operation of the AC MOSFET switch by a control circuit to supply current to the inductive load from time 0 to the end of a two second startup period 1220. Note that the amount of time for a start up period may vary. For a circuit, the start up period may depend upon the characteristics of the AC inductive load in that circuit. For example for some inductive motors, five seconds may be desirable for the startup period. Such a linear duty ration operation of the AC MOSFET switch may be accomplished by utilizing a pulse wave modulation scheme in the control circuit. FIG. 12B illustrates the current delivered to an embodiment of an AC load over a two second duty ratio ramp up period corresponding to FIG. 12A.

FIG. 13 illustrates a duty ratio for operating an embodiment of an AC MOSFET switch during startup, in accordance with another embodiment. As illustrated, the duty ratio may begin at a 0.2 duty ratio 1310 instead of 0. This initial non-zero duty ratio start is to provide better startup characteristics for an AC load. For example, in the case of an AC induction motor, a quicker spin up of the motor may be obtained by using an initial 0.2 duty ratio. The remainder of the duty ratio illustrates a linear increase until the duty ratio approaches 1 at the end of a five second ramp up period. The time period of the ramp may be chosen to provide the desired motor starting characteristics along with the desired motor current profile, in this embodiment five seconds is the ramp period. In other embodiments different time periods for the ramp may be utilized. While there may still be an initial transient as a result of this initial step, the transient will be considerable smaller then the 5-times rated current surge that occurs with no soft start functionality.

While the soft start methods are discussed with respect to an induction motor, the techniques apply to any load driven by the AC MOSFET switch, such as the resistive heating element in a printer fusing system or induction heating elements previously described. In addition, while a linear ramp of the current is utilized, one skilled in the art will recognize that other, non-linear ramping of the current to the load may be obtained using the AC MOSFET switch. Further, a similar, but inverse, current ramping can be utilized during the load turn-off to provide further advantages during the power down of the AC load. For example, during the turn-off of certain AC loads, flickering can occur on adjacent incandescent and fluorescent lighting systems. A ramped turn-off of the load driven by the AC MOSFET alleviates this problem.

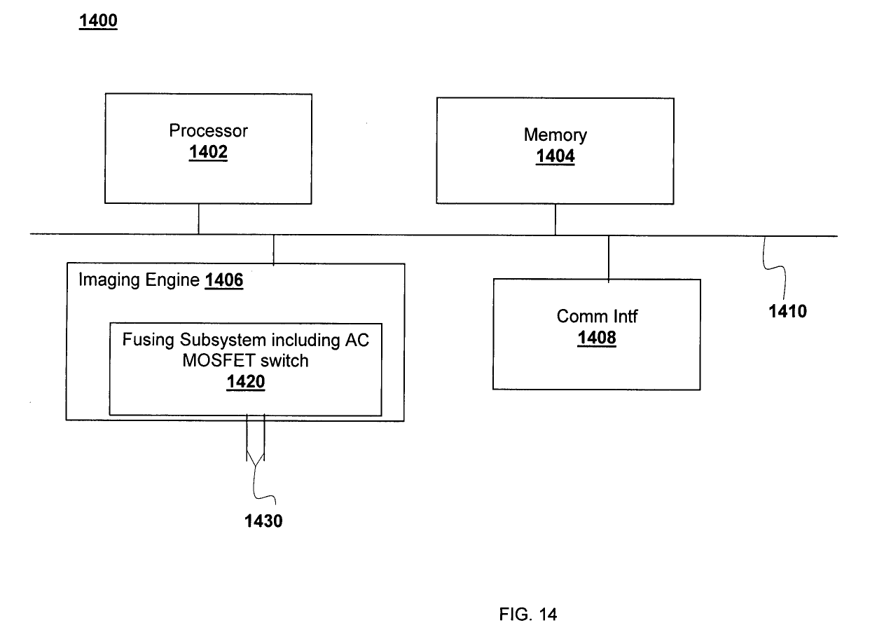

FIG. 14 illustrates an embodiment of an imaging system 1400, suitable for housing an apparatus utilizing an embodiment of an AC MOSFET switch driving an AC load, in accordance with one embodiment. As illustrated, for the embodiment, imaging system 1400 includes processor/controller 1402, memory 1404, imaging engine 1406 and communication interface 1408 coupled to each other via bus 1410. Imaging engine 1406 comprises a fusing subsystem 1420 for fusing toner to paper. In addition to fusing subsystem, imaging system may comprise other inductive heating elements or induction motors. Imaging engine 1406 is similar to those found in many imaging systems, such as those available from Hewlett Packard Corp. of Palo Alto, Calif. Fusing subsystem 1420 is connected to an alternating current power source through interface 1430.

Processor 1402, in combination with other portions of the imaging system 1400, can perform various control functions of the fusing subsystem 1420. For example, in one embodiment, processor 1402 controls power management of the fusing subsystem 1420 to intelligently power down the fusing subsystem when the fuser is not in use. Otherwise, processor 1402, memory 1404, imaging engine 1406, comm. interfaces 1408, and bus 1410 represent a broad range of such elements.

In various embodiments, imaging device 1400 may be an inkjet printer or an electrophotographic printer.

Thus, various embodiments are illustrated utilizing an AC MOSFET switch in a circuit delivering current to a load, including an inductive load. Although specific embodiments have been illustrated and described herein, it will be appreciated by those of ordinary skill in the art that a variety of alternative and/or equivalent embodiments may be substituted for those disclosed herein without departing from the spirit and scope of this disclosure. This application is intended to cover any adaptations or variations of the embodiments discussed herein. Therefore it is intended that the present invention be limited only by the claims and the equivalents thereof.

1. An apparatus comprising:
a switching circuit comprising:
a first Field Effect Transistor (FET) having a first source, a first gate and a first drain;
a second FET having a second source coupled to said first source and a second gate coupled to said first gate;
a first diode having a first anode coupled to said first source and a first cathode coupled to said first drain; and
a second diode having a second anode coupled to said second source and a second cathode coupled to said second drain;
a load coupled to said switching circuit; and
a control circuit coupled to said switching circuit.

2. The apparatus of claim 1 wherein said control circuit to facilitate controllable current delivery through the switching circuit to said load.

3. The apparatus of claim 2 wherein said controllable current delivery comprises linear duty ratio current delivery.

4. The apparatus of claim 3 wherein said linear duty ratio current delivery occurs during a start up period of said load.

5. The apparatus of claim 4 wherein said start up period is one second.

6. The apparatus of claim 1 wherein said control circuit comprises a pulse wave modulation circuit.

7. The apparatus of claim 1 wherein said control circuit comprises a variable frequency drive.

8. The apparatus of claim 1 further comprising a low pass filter circuit.

9. The apparatus of claim 8 wherein said low pass filter circuit comprises a series resonant low pass filter.

10. The apparatus of claim 1 wherein said load comprises an inductive heating device.

11. The apparatus of claim 10 wherein said inductive heating device comprises an inductive coil.

12. The apparatus of claim 1 wherein said load comprises a single phase induction motor.

13. The apparatus of claim 12 further comprising a free wheel capacitor coupled to said single phase induction motor.

14. The apparatus of claim 1 wherein said load comprises a fuser.

15. The apparatus of claim 14 wherein said fuser comprises a resistive element heating lamp.

16. The apparatus of claim 1 further comprising a snubber circuit coupled to said first drain and said second drain.

17. The apparatus of claim 1 further comprising a bias circuit coupled to said control circuit.

18. The apparatus of claim 1 further comprising a temperature sensor coupled to said control circuit and said load.

19. The apparatus of claim 1 wherein the switching circuit comprises a first AC MOSFET switch, the apparatus further comprising a second AC MOSFET switch coupled to the first AC MOSFET switch and coupled across the load.

20. The apparatus of claim 19 wherein the control circuit provides for a dead time between on-times for the first and second AC MOSFET switches.

21. An imaging system comprising:
a processor; and
an imaging system coupled to said processor, said imaging subsystem including:
a switching circuit comprising:
a first Field Effect Transistor (FET) having a first source, a first gate and a first drain;
a second FET having a second source coupled to said first source and a second gate coupled to said first gate;
a first diode having a first anode coupled to said first source and a first cathode coupled to said first drain; and
a second diode having a second anode coupled to said second source and a second cathode coupled to said second drain;
a load coupled to said switching circuit; and
a control circuit coupled to said switching circuit.

22. The imaging system of claim 21 wherein said load comprises an inductive heating device.

23. The imaging system of claim 21 wherein said load comprises a single phase induction motor.

24. The imaging system of claim 21 wherein said load comprises a fuser.

25. A method of control of alternating current in a circuit comprising:
during a first state of the circuit, controlling a plurality of MOSFETs to permit alternating current flow through the circuit by enabling a flow of alternating current through the plurality of MOSFETs; and
during a second state of the circuit, controlling the plurality of MOSFETs to inhibit alternating current flow through the circuit by disabling the flow of alternating current through the plurality of MOSFETs such that when a voltage across the plurality of MOSFETs is at a positive polarity, a first explicit antiparallel diode corresponding to a first MOSFET inhibits current flow through the circuit and, when the voltage across the plurality of MOSFETs is at a negative polarity, a second explicit antiparallel diode corresponding to a second MOSFET inhibits current flow through the circuit.

26. The method of claim 25 wherein the first and second state of the circuit are modulated with a pulse width modulation.

27. The method of claim 25 wherein the first and second state of the circuit are modulated with a variable frequency.

28. The method of claim 25 wherein, during the second state of the circuit, stored energy in the circuit is dissipated through at least one of the first and second explicit anti-parallel diodes and a snubber circuit.

29. An apparatus comprising:
means for control for, during a first state of a circuit, controlling a plurality of MOSFETs to permit alternating current flow through the circuit by enabling a flow of alternating current through the plurality of MOSFETs; and, during a second state of the circuit, controlling the plurality of MOSFETs to inhibit alternating current flow through the circuit by disabling the flow of alternating current through the plurality of MOSFETs
a plurality of means for inhibiting current flow such that when a voltage across the plurality of MOSFETs is at a positive polarity, a first means for inhibiting current flow corresponding to a first MOSFET inhibits current flow through the circuit and, when the voltage across the plurality of MOSFETs is at a negative polarity, a second means for inhibiting current flow corresponding to a second MOSFET inhibits current flow through the circuit.

30. The apparatus of claim 29 wherein the first and the second means for inhibiting current flow each comprise an explicit antiparallel diode.

31. The apparatus of claim 29 further comprising a means for dissipating stored energy of the circuit during the second state.

32. The apparatus of claim 29 further comprising a means for biasing to bias the means for control.

33. The apparatus of claim 29 wherein said means for control comprises a pulse wave modulation circuit.

34. The apparatus of claim 29 wherein said means for control comprises a variable frequency drive.

35. The apparatus of claim 29 further comprising a means for filtering to pass low frequency signals.
